(19) United States
(12) Patent Application Publication
(10) Pub. No.: US 2008/0070697 A1
(43) Pub. Date: Mar. 20, 2008

(54) SOCIAL INTERACTION GAMES AND ACTIVITIES

(75) Inventors: Merle Michael Robinson, Redmond, WA (US); Eric James Hennings, Seattle, WA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ICEBREAKER, INC., George Town (KY)

(21) Appl. No.: 11/855,911

(22) Filed: Sep. 14, 2007

Related U.S. Application Data
(60) Provisional application No. 60/825,851, filed on Sep. 15, 2006.

(51) Int. Cl. A63F 13/12

(52) U.S. Cl. 463/42

(57) ABSTRACT

A mobile social interaction system that enables users to participate in social networking games and activities via handheld and/or mobile devices is provided. User profiles or other criteria can be employed in order to facilitate matching candidates within a gaming environment. The innovation enables the users to communicate within a gaming environment via voice, video and/or text messaging communications.

### CROSS-REFERENCE TO RELATED APPLICATIONS

This application claims the benefit of U.S. Provisional Patent application Ser. No. 60/825,851 entitled “MOBILE SOCIAL NETWORK”, filed on Sep. 15, 2006 and is related to U.S. patent application Ser. No. 11/456,397 entitled ‘SOCIAL INTERACTION SYSTEM’, filed on Jul. 10, 2006, and to U.S. patent application Ser. No. ______ entitled ‘SOCIAL INTERACTION MESSAGING AND NOTIFICATION’, filed on ______, and to U.S. patent application Ser. No. entitled ‘SOCIAL INTERACTION TAGGING’, filed on ______, and to U.S. patent application Ser. No. ______, entitled ‘LOCATION-BASED SOCIAL INTERACTION NETWORK’, filed on ______, and to U.S. patent application Ser. No. entitled ‘DATE MANAGEMENT WITHIN A SOCIAL INTERACTION NETWORK’, filed on ______. The entireties of the above-noted applications are incorporated by reference herein.

### BACKGROUND

The Internet continues to make available ever-increasing amounts of information which can be stored in databases and accessed therefrom. Additionally, with the proliferation of portable terminals (e.g., notebook computers, cellular telephones, personal data assistants (PDAs), smartphones and other similar communication devices), users are becoming more mobile, and hence, more reliant upon information accessible via the Internet. Accordingly, the connectivity available via the Internet is frequently used to chat, socialize and communicate with friends and family.

One particular area in which the Internet is becoming popular is in the field of Internet dating and other social interaction services generally. An Internet dating service, or online dating, allows people to meet and get acquainted online thereafter potentially engaging in a romantic relationship. Conventional dating services are oftentimes moderated by a third party who matches candidates based upon criteria and/or preferences (e.g., profile data).

These online dating services enable a user to create a profile which can contain information relating to physical as well as personal characteristics. As well, these online dating services enable a user to search profiles of other candidates in order to locate a match based upon a predetermined set of criterion. For example, a user can search upon physical characteristics such as age, height, weight, hair color, etc. As well, personal characteristics such as income, interests, hobbies, religion, etc. can be used to search profiles.

Online dating or Internet dating continues to expand in popularity as more and more people become acquainted with the Internet and its vast communication resources. Effectively, the seemingly anonymity of the Internet alleviates much of the apprehension and pressures associated with face-to-face communication felt by many individuals. As stated above, the overall structure of online dating services enables a person to post a personal profile and to respond to requests without ever speaking a word. Rather, all initial communication is of the form of a text message and reply thereto. Most often, this communication is un-moderated which, unfortunately, enables untruthfulness and lack of full disclosure. For instance, in accordance with the profiles, it is not uncommon for a participant to be untruthful with respect to personal characteristics such as, age, height, weight, income, profession, etc.

Overall, online dating or internet dating services enable people to meet online and possibly develop a friendship, a romantic or even sexual relationship. These online dating services enable individuals to provide personal information, for example, age, gender and location. Accordingly, the services promote others to search these individuals using the profile criteria. As well, many dating services allow members to include a photo in their profile which can be searched by others. Oftentimes, online matchmaking sites offer additional services, such as online chats, and message boards that enhance the matchmaking experience.

In general, online dating services operate by the same criteria as typical relationships. However, factors specific to the nature of online communications may affect the experience. There are many positive factors that can inherently enhance the online experience. For example, online dating sites facilitate individuals to meet more people than they would without such sites. As well, online matchmaking sites enable individuals to easily browse other members' profiles before deciding to initiate communication. Essentially, these online dating services enable users to break down geographic barriers while enabling users to learn more about a prospect or candidate before actually expending the time and effort to pursue a meeting. In today's busy society, the value added by the ability to pre-screen candidates is very desirable.

However, the aforementioned positive effects do not come without drawbacks. One of the most common negative effects of online matchmaking services is that people often misrepresent themselves. For example, it is not uncommon for individuals to be untruthful about their marital and/or relationship status, age, gender, physical attributes or socio-economic status. The mere post of a profile makes it easy for a user to be untruthful about individual criteria as well as to post a photo that is not current or even a photo that is not really that of the individual.

Conventional dating services have begun to migrate into today's mobile society. More particularly, recent developments have been directed to employing matchmaking services via mobile devices such as cell phones, smart-phones, etc. However, because most of these conventional mobile systems are nothing more than a mobile version of the traditional Internet dating systems, they have been plagued with slow response time, widespread deception and lack of interactivity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a mobile social interaction service that enables users to communicate to desired individual(s) (e.g., candidates) via handheld and/or mobile devices by participating in a variety of games and/or activities. It will be understood and appreciated that the user profiles or other criteria can be employed in order to facilitate matching candidates within gaming environments.

Essentially, the innovation enables games with only text, games with voice, games with video, picture-based video, picture-based voice, picture-based text, as well as combinations thereof. Within these examples, games based upon photos as well as inquiries are presented. Specific gaming examples include ‘Right Now,’ ‘Babyface,’ ‘What would you do?,’ ‘Eliminate,’ ‘20 Questions,’ ‘Spin the Bottle,’ and ‘Speed Dating.’

In aspects, the innovation enables the users to anonymously communicate via voice communications. In another aspect, the innovation provides for anonymous video communication. In yet another aspect, the innovation provides for anonymous text messaging communication. Although anonymous communication is disclosed, it is to be understood that, in aspects, identity information can be conveyed as desired.

Still other aspects of the subject innovation provide for the ability to schedule a time for a meeting (e.g., call) with one or more members of a service. Additionally, upon arrival of the scheduled time, if the application is not currently active, the system can automatically launch the application/service or alternatively, prompt a user with regard to launching the application. Accordingly, the novel systems described herein can be employed to facilitate making (e.g., scheduling) a date, meeting or encounter. It is to be understood and appreciated that ‘date’ is used herein to describe any social encounter without regard to any physical involvement of a romantic encounter.

In yet another aspect thereof, an artificial intelligence (AI) or machine learning & reasoning components are provided that employ a probabilistic and/or statistical-based analysis to infer an action that a user desires to be automatically performed. For example, AI can be employed to automatically select candidates to participate in a game and/or schedule a meeting.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates gaming and anonymous communication in a social matching environment in accordance with an aspect of the innovation.

FIG. 2 illustrates an example communication exchange between two wireless devices in accordance with the subject matter of the innovation.

FIG. 3 illustrates an example flow chart of procedures that facilitate anonymous communication in accordance with an aspect of the innovation.

FIG. 4 illustrates an example flow chart of procedures that facilitate suspending an application/service with respect to an anonymous voice communication in accordance with an aspect of the innovation.

FIG. 5 illustrates an alternative communication system that facilitates suspending and restoring a service based upon a state in accordance with an aspect of the innovation.

FIG. 6 illustrates an example gaming/activity component that facilitates photo and/or inquiry-based games/activities in accordance with aspects of the innovation.

FIG. 7 illustrates an example photo management component in accordance with an aspect of the innovation.

FIG. 8 illustrates an example inquiry management component in accordance with an aspect of the innovation.

FIG. 9 illustrates an alternative system diagram having a server that includes a connection manager that facilitates control of the anonymous communications between devices in accordance with an aspect of the novel subject matter.

FIG. 10 is a schematic block diagram of a portable handheld device according to one aspect of the subject invention.

FIG. 11 illustrates an architecture of a portable handheld device including an artificial intelligence-based component that can automate functionality in accordance with an aspect of the invention.

FIG. 12 illustrates an exemplary failsafe application restart process flow in accordance with an aspect of the innovation.

FIG. 13 illustrates a block diagram of a computer operable to execute the disclosed social interaction service architecture.

FIG. 14 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms ‘component’ and ‘system’ are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to ‘infer’ or ‘inference’ refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

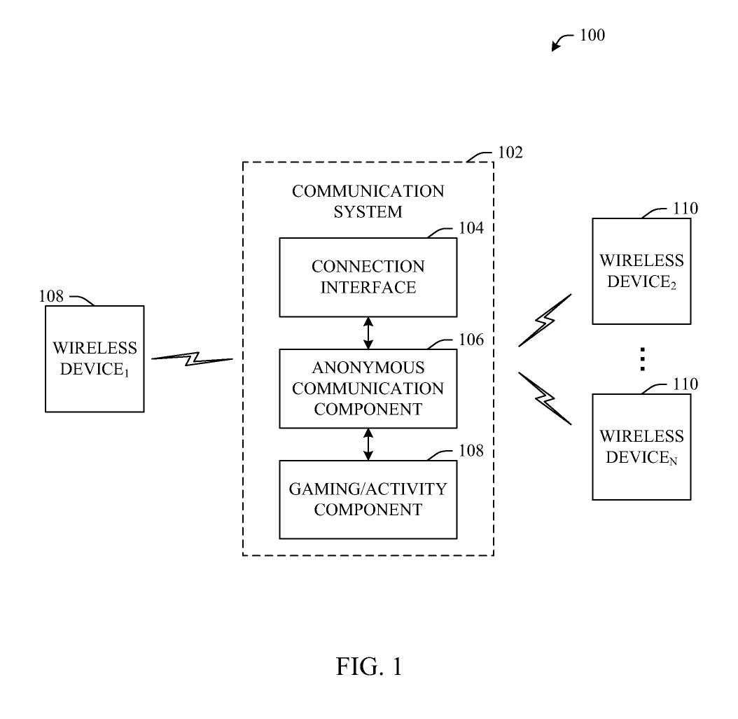

Referring initially to FIG. 1, the subject innovation is directed to a system 100 (and method) that enhances traditional social networking systems by providing various games and activities to enhance connecting individual. These games and activities can particularly add to the basic review of a profile. In other word, rather than a user merely searching profiles of potential candidates, the games and activities within the social networking environment provide for real-life and impromptu information to be revealed. Thus, users are provided with more information than a prepared profile when making connection (or ‘crush’) decisions. Additionally, users may meet individuals that they would rather not have met if they were to rely upon a profile alone.

As used herein, a ‘crush’ refers to a situation where a user expresses interest in another candidate. To the contrary, a ‘flush’ refers to when a user is not interested or otherwise decides to ‘pass’ on a candidate. As will be understood upon a review of the Related Applications set forth above, in most embodiments, upon a ‘mutual crush,’ the parties are able to communicate, e.g., privately and/or anonymously.

Essentially, in aspects, system 100 enables users to engage in gaming (or other social activities) by way of anonymous communication. While many of the aspects described herein are directed toward anonymous communication in the gaming environment(s), it is to be understood that the anonymous communication feature is optional and that other aspects exist wherein identities are revealed. These alternative aspects are to be included within the scope of this disclosure and claims appended hereto.

In disparate aspects, the system 100 can facilitate social interaction games that include communication via voice, video, text, picture messaging or any combinations thereof. Embodiments can include games or activities without voice, with voice, with video, without video, with images, without images, with only text, etc. Additionally, it will be understood that users can define subgroups of candidates for a game. For instance, a user can opt to only play with candidates from the same city, zip code, etc. While specific examples are given herein, it is to be understood that the embodiments described infra are provided to add perspective to the types of games and activities that can be employed to prompt interaction. As such, these aspects are not intended to limit the innovation in any way.

In operation, the system 100 illustrated in FIG. 1 can facilitate suspension of a game or activity application upon commencement of a communication session. Accordingly, upon termination of the communication session, the novel system 100 can restore the application based upon the state of the service (e.g., game, activity) at the time of suspension. In operation, the state can be transferred to the communication system thus enabling a user the ability to continue to interact with the system or other users within the activity environment.

The following scenarios are directed to gaming and activities within a social interaction (e.g., matchmaking) scenario. While the use of this technology in this social interaction service environment is disclosed, it is to be understood and appreciated that the features, functions and benefits of the innovation (e.g., games, activities, anonymous communication, service suspension/restoration, feedback generation . . . ) can be employed in connection with any scenario where a service is employed to connect parties and/or communication (anonymous or otherwise) is desired. By way of example, the novel systems and functionality of the innovation can be employed in business-related team building exercises or the like.

Generally, system 100 can include a communication system component 102 that can facilitate the gaming, activities, anonymous communication and service suspension functionality of the innovation. As shown, the communication system component 102 can include a connection interface component 104, an anonymous communication component 106, and a gaming/activity component 108. The functionality of each of these components will be described in greater detail with respect to the figures that follow.

As illustrated in FIG. 1, the communication system component 102 can be employed to facilitate communications between wireless devices (108, 110). By way of particular example, the communication system component 102 can be employed to connect parties in a chat room environment where anonymity is desired.

Referring again to the subcomponents (104, 106, and 108) of the communication system component 102, the connection interface component 104 can manage details with respect to a desired communication. For instance, the connection interface 104 can be employed to identify the parties, schedule or connect the communication session, suspend and/or restore a social service, etc. More particularly, as shown in the figures that follow, the connection interface 104 can include the service that effectuates locating and selecting a party (e.g., candidate) for which to connect.

In operation, the connection interface component 104 interacts with the anonymous communication component 106 and the gaming/activity component 108 in order to trigger the desired communication session. As described supra, this communication session can be a voice communication session, a video communication session, a picture-based session, a text messaging communication session or any combination thereof. All in all, it will be understood that it is a feature of the innovation to enable two (or more) parties to agree to communicate thereafter being connected anonymously via the communication system component 102.

As stated above, it is to be understood that anonymous communication is optional to the innovation and is not to be considered limiting to the scope of the disclosure in any manner. Rather, it is to be understood that identity information can be conveyed as desired in accordance with alternative aspects. These alternative aspects are to be included within the scope of the disclosure and claims appended hereto.

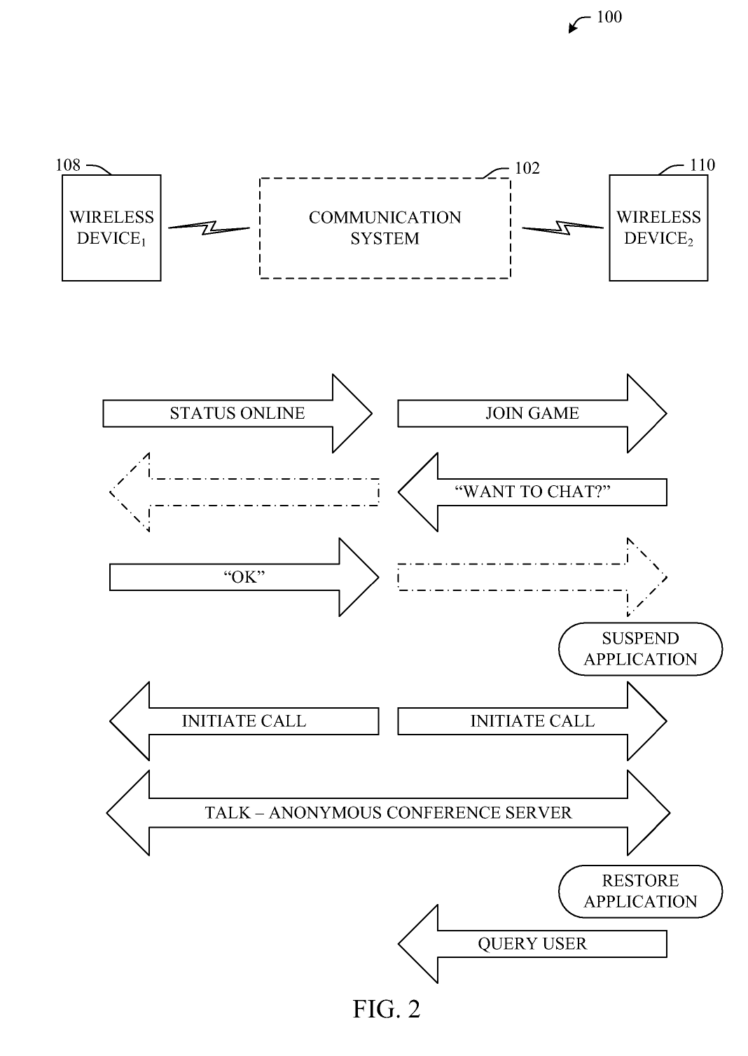

Turning now to FIG. 2, an example communication exchange between two wireless device users (108, 110) in accordance an aspect of the innovation is shown. This example communication exchange is included to add perspective to the innovation in that it provides a foundation of functionality used by the gaming/activity component (e.g., 108 of FIG. 1).

As described above, although this exchange is directed to an exchange between two users, it is to be understood that the exchange can be employed in connection with any number of users in alternative aspects. To this end, it will be understood that the features of anonymous communication and application (e.g., game, activity) or service suspension/restoration can be employed in connection with any network of users.

Moreover, it will be understood that most any wireless communication devices can be employed in connection with alternative aspects. By way of example and not limitation, the wireless devices (108, 110) shown can be cell phones, smart-phones, personal data assistants (PDAs), laptops, personal computers (PCs) or the like. Although the scenarios described herein are directed to employing the functionality in connection with ‘wireless’ devices, it is to be understood that wired devices (or combination of wired and wireless devices) can also be employed in connection with the functionality described herein. In a specific example, in an aspect, the innovation provides for the ability for a user click on a link to call somebody and have a landline ring (rather than the wireless device as described in detail herein). For example, while playing a game, users can be transferred into a virtual ‘chat room’ regardless of the device employed.

As shown in FIG. 2, a first wireless device user (e.g., 108) can launch an application or service within the communication system component 102, e.g., trigger an online status. As will be described herein, the user can launch a social interaction service or gaming application. Once the social interaction service is launched, the user can join a game being played between other online users. For instance, and as will be described greater detail infra, a user can join a game of ‘20 Questions.’ Here, the first wireless device user (e.g., 108) can answer questions posed by a designated leader of a game (e.g., 110) in an effort become the winner and ultimately the ‘mutual crush’ with the leader, which results in an ability to communicate privately. Still further, it is to be understood that, at any time during play, users can designate crushes upon each other—in which case, if mutual, results in an ability to communicate privately.

In accordance with the scenario of FIG. 2, at an appropriate time in game play (e.g., when all other users are eliminated), the second user (110) can send a message to invite the first user (108) to talk by sending the message ‘Want to chat?’ In reply, the first user can accept the invitation by sending a message to the effect of ‘OK.’ At this point in the operation, the communication system component 102 can record the state of the social interaction service application and suspend the application (e.g., gaming component 108) in accordance with the state.

By way of more specific example, once the invitation is accepted and the connection is commenced, the state can be recorded. The state can reflect the game being played, a user's status within the game, a list of participants, etc. By suspending the application, the user will be able to continue within the game at the place in time preceding the acceptance of the invitation.

Once the state is recorded and the application is suspended, as shown, a communication (e.g., anonymous communication) session (or call) can be initiated. As described above, this communication session can be a voice call, a video call, picture messaging, a text messaging session, or combination thereof. As illustrated, in this scenario, the users (108, 110) can talk via the anonymous conference server (e.g., communication system component 102).

Upon termination of the communication session, the social interaction application can be restarted based upon the recorded state at the time of the service suspension. It is to be understood that by restoring the application to the state just prior to initiation of the call, a user can continue where they left off. For example, the user can return to the game.

It will be appreciated that the aforementioned functionality is not traditionally possible because most conventional wireless devices (e.g., cell phones) do not allow voice calls and data services to run simultaneously. For at least this reason, conventional systems cannot enable the seamless transition between a social interaction application and a voice (or video) call. As described above, in one aspect, the innovation can suspend and restart the data service to create a seamless experience for the users when a phone call is activated.

Referring again to FIG. 1, gaming/activity component 108 facilitates incorporation of interactive games as an application between users (or devices). As will be described in detail below, the games can include most any game or type of entertainment. By way of example, and not limitation, the games can include photo-based games, question/chat-based games or the like. Additionally, other types of games are contemplated and are to be included within the scope of this specification. For instance, theme-based games such as trivia (e.g., sports trivia, '80s trivia, and movie trivia), education, etc. are to be included within the scope of the innovation described herein.

Most current downloadable and WAP (wireless application protocol) games for the mobile device or phone are solitary games, although users would like to use the phone to interact with others. Additionally, in accordance with conventional systems, when users interact via mobile device, they typically send text messages back and forth asynchronously. Here, the gaming/activity component 108 of the innovation discloses social games and activities that introduce and assist users to learn more about each other in a real-time format.

The gaming/activity examples described herein are generally related to three groupings. In aspects, these games can include, but are not limited to include, data-based games without voice, games with voice, and third and fourth generation (3G and 4G) communication system games with simultaneous data, voice and video.

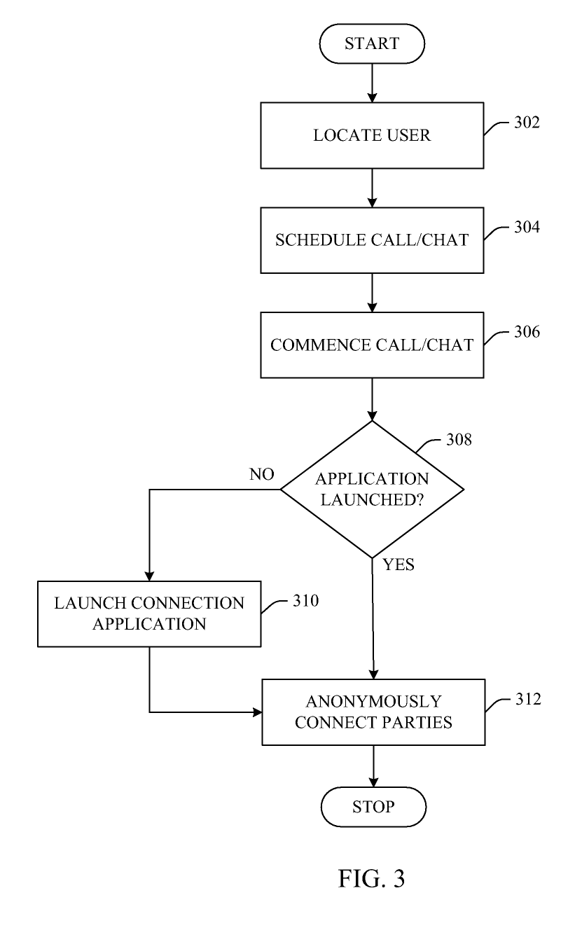

FIG. 3 illustrates a methodology of the anonymous communication (106 of FIG. 1) with respect to a social interaction application in accordance with an aspect of the innovation. While, for purposes of simplicity of explanation, the one or more methodologies shown and/or described herein, e.g., in the form of a flow chart or textual description, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, a user can be located via the service of a social interactive system or other social application. Once a candidate (or group of candidates) is identified, a call (or chat) can be scheduled at 304. For example, the call/chat can be scheduled for a time convenient to the parties involved. Alternatively, the call can be scheduled in accordance with a particular game/activity.

The call/chat can be commenced or initiated at 306. In other words, the call can be initiated in accordance with a schedule set forth in 304. More particularly, the schedule can be set to automatically commence the call at a particular time/date. At 308, a decision can be made at 308 if the necessary application is launched in order to commence the call. More particularly, in a scenario, a user can employ a social interaction service application to schedule the call at 304. However, at the scheduled time, the application may not be active therefore requiring a prompt or auto-launch to make the application available to accomplish the connection.

If, at 308, it is determined that the application is not pre-launched, the connection application can be launched at 310. On the other hand, if the application is pre-launched (or launched at 310), the parties can be anonymously connected at 312. Following, a stop block is reached.

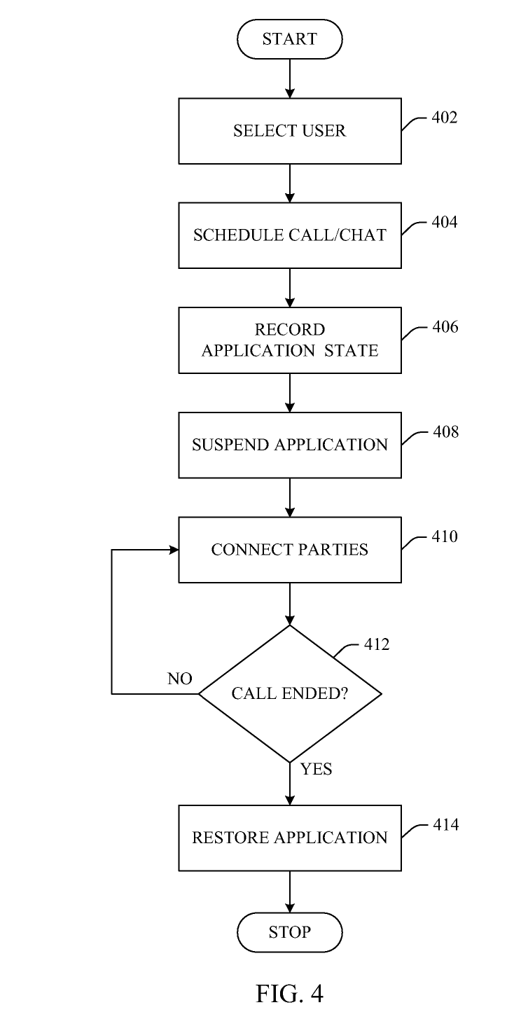

FIG. 4 illustrates a methodology of the novel seamless transition between the service and the anonymous communication in accordance with an aspect of the innovation. At 402, one user can select another, can select a group of users, or the parties can mutually select each other. As will be described below, this selection can be the result of a social interaction gaming application. At 404, a call can be scheduled between the parties. Here, users (two or more) agree to engage in an anonymous communication (e.g., voice call). The parties can schedule the call to occur immediately, or at some later time. As well, when the call is scheduled, the parties can determine if the call is to last for a specific period or be indefinite in time, depending upon the service prescription and/or user decisions.

Upon arrival of the scheduled time, at 406, the state of the service or social interaction service application is recorded. Subsequently, the social interaction service application can be suspended at 408. In other words, the application can be halted at the point where the user was when the call was initiated.

Next, the parties can be connected at 410. As described with reference to FIG. 3, the parties can be anonymously connected at 410. Furthermore, it will be understood that this connection can be a voice call, a video call, picture message and/or a text message chat. A determination is made at 412 if the communication (e.g., call) has ended. If the call has not ended, the system returns to 410 and maintains the connection of the parties in accordance with the schedule set forth in 404.

Once the call terminates, the service can be restored at 414. In other words, the recorded state can be recalled thereby effectuating the restoration of the application in accordance with the state just prior to the commencement of the communication. Next, a stop block is reached.

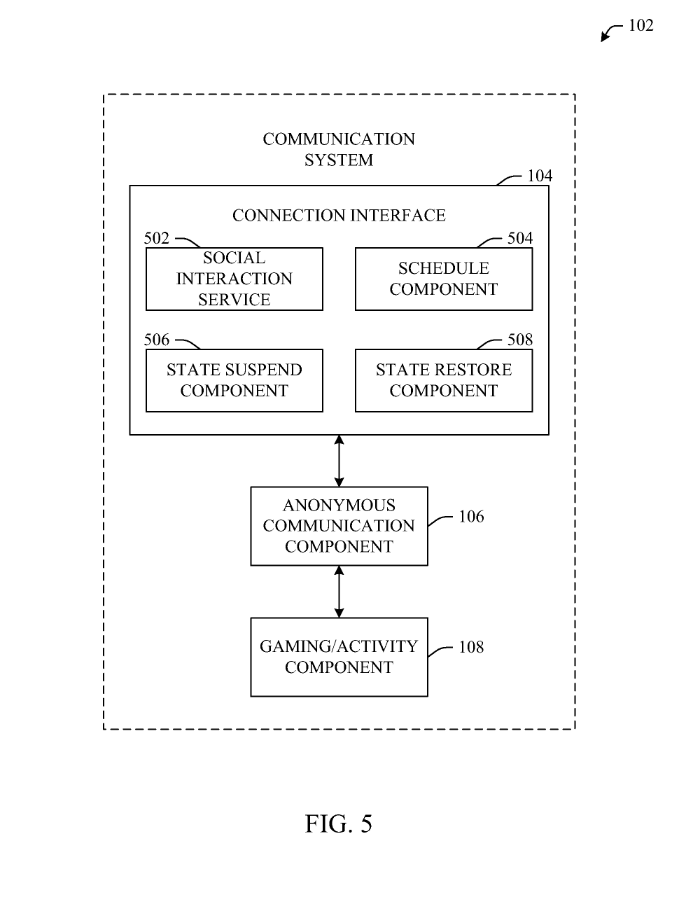

Turning now to FIG. 5, an alternative block diagram of communication interface component 102 is shown. As described with reference to FIG. 1, the communication interface component 102 can include a connection interface component 104, an anonymous communication component 106 and a gaming/activity component 108.

As shown in FIG. 5, the connection interface component 104 can include a social interaction service component 502 and a schedule component 504. Although the social interaction service component 502 is shown inclusive of the connection interface component 104, it is to be understood that this component 502 can be located external and/or remote from the connection interface component 104 (and communication system 102) in alternative aspects.

In one particular aspect, the social interaction service component 502 can be representative of a mobile dating service where members/candidates can enter a profile and/or browse profiles of other members/candidates. Although a mobile dating service is described herein, it is to be understood that the features (e.g., gaming, anonymous communication, and service suspension/restoration) can be employed in other scenarios where an application or service is used to schedule a conversation or meeting between individuals.

As well, it is to be appreciated that the innovation discloses an ability to provide simultaneous data and voice paths. For instance, the innovation can be used in a scenario where a user employs a PC (e.g., webcam) and a phone simultaneously to effect communication. Those skilled in the art will be able to appreciate other aspects that can utilize the functionality described herein. As such, these additional aspects are to be included within the scope of this innovation and claims appended hereto.

Continuing with the discussion of the connection interface component 104 of FIG. 5, a schedule component 504 can be provided that enables users to schedule a meeting (e.g., conversation). For instance, a conversation can be scheduled for a time and date that is convenient to each of the parties. Similarly, in a disparate scenario, a meeting can be scheduled to take place in a virtual ‘chat room’ or the like. In any case, the schedule component 404 can facilitate identifying a time (and place) that the parties desire to be connected.

As described above, another feature of the innovation is the ability to suspend and restart an application and/or service upon commencement and termination of a meeting (e.g., call, chat) respectively. This functionality can be effectuated by the state suspend component 506 and the state restore component 508 illustrated inclusive of the connection interface 104. While the state suspend and state restore components (506, 508) are shown as separate components inclusive of the connection interface 104, it is to be understood that the functionality of these components (506, 508) can be collocated within a single component. As well, it will be understood that these components can be external to the connection interface component 104 without departing from the spirit and scope of this innovation and claims appended hereto.

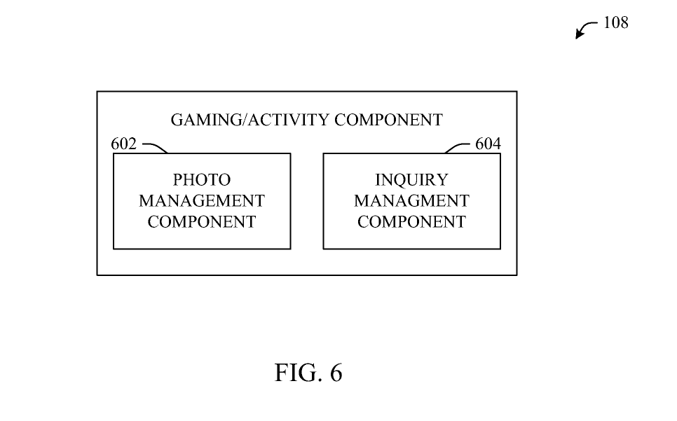

FIG. 6 illustrates an example block diagram of gaming/activity component 108 in accordance with an aspect of the innovation. As shown, the gaming/activity component 108 can include a photo management component 602 and/or an inquire management component 604. In operation, these components can administer photos and inquires as used in games or other social networking activities.

The photo management component 602 can be employed to receive, manipulate, configure and render photos in connection guidelines set forth in numerous games. For instance, in one example game, users can transmit a variety of photos (e.g., head, torso, legs, feet) to the gaming component 108. Thereafter, the photo management component 602 can mix-and-match photos of multiple users thereby generating humorous views of the users. For example, the system can put the head of User 1 on the torso of User 2 with the legs of User 3, and so on. As will be described in greater detail below, morphing technologies can also be employed to morph facial features of each user thereby generating a mixed-view (e.g., ‘Babyface’ as described infra).

The inquiry management component 604 can be employed to generate, administer and/or direct questions to users in accordance with a game or activity. For example, in a random trivia scenario, the inquiry management component 604 can be employed to generate or select questions from an inventory of questions. Alternatively, where the questions are user-generated, the inquiry management component 604 can facilitate communication from one user to another. Here, if desired, the component 604 can, among other things, censor the questions in order to remove any profanity, offensive language, or the like.

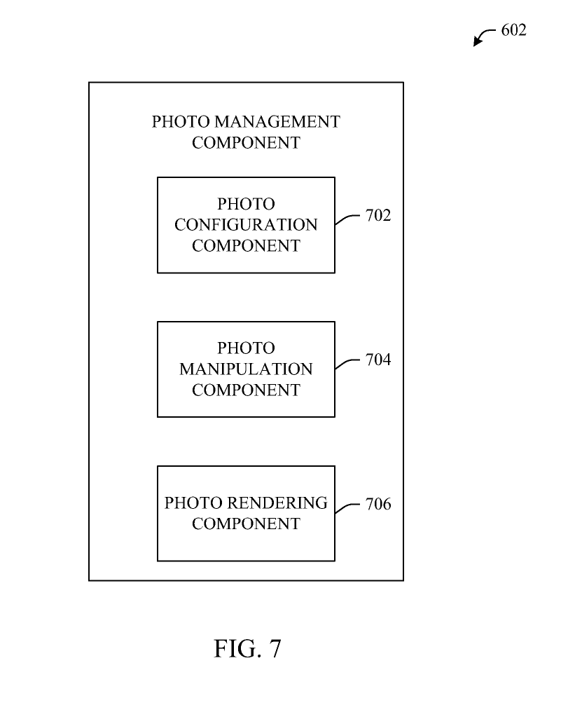

Referring now to FIG. 7, an example block diagram of a photo management component 602 is shown. Generally, photo management component 602 can include a photo configuration component 702, a photo manipulation component 704 and/or a photo rendering component 706. The functionality of each of these components is described with reference to specific games/activities below.

The following examples are directed to photo-based games. It is to be understood that the aforementioned components (e.g., social interaction service, schedule component, state suspend component, state restore component) can be employed to enable these games. More particularly, when a user leaves a game, for example to visit a private chat room, the game application can be suspended and restored to the same state upon returning from the private chat. These and other features will become more evident upon a review of the figures that follow.

Photo-based games are games that encourage users to interact via photos and text chat (as well as voice chat if desired). Since many of the games require new photos be taken to participate, they encourage honesty and confidence. It will be appreciated that old and/or doctored photos have traditionally created frustration and anger in social applications, especially Internet and mobile dating, because they exposed dishonesty when the users eventually meet in a real setting.

Unlike conventional systems, these games/activities can create a real, live, exciting atmosphere, thereby promoting honesty and confidence. The games also assist users in demonstrating their creativity as they learn more about each other. During the decision period, chat discussions occur to create a social atmosphere, at least until the time expires.

Turning now to a couple examples of photo-based gaming environments. A first example can be referred to as ‘Right Now.’ In this example, using a small number of photos (e.g., 3 or 4), two (or more) users can describe to each other what they look like ‘right now.’ As will be appreciated, the ‘right now’ aspect inherently enhances trust, honesty and confidence.

In this example, users can capture four photos of themselves, for example via a camera phone (or webcam). In an example, the pictures can be representative of the user's face, torso, hips, legs, and feet. Next, the pictures can be sent to a server (e.g., communication system 102 of FIG. 1). Thereafter, the photo configuration component 702 can be employed to combine, in vertical order, on the screen to create a humorous representation of the user.

The photo rendering component 706 enables the user to switch between different views of the data. For instance, the photo rendering component 706 enables a representation of the other user, a representation of him/her, or a side-by-side view of both representations. It will be appreciated that the latter could provide a humorous view of what the two would look like as a couple.

Still further, it is to be understood that the photo configuration component 702 in addition to the photo rendering component 706 can be employed to automatically resize or dynamically adjust the photo in accordance with a target device. For instance, the photo management component 602 can dynamically format the photo(s) differently for a PC versus a smart-phone.

Another example of a photo-based social networking game can be referred to as ‘Babyface.’ One way of encouraging two people to playfully flirt is by helping them think about what their baby would look like. The ‘Babyface’ experience could employ the photo manipulation component 704 at follows:

In this scenario, users would capture photos of their faces with their camera phone. The photos can be sent to the server (e.g., communication system 102), where the photos can be modified and/or combined by the photo manipulation component 704. For instance, the photo manipulation component 704 can identify and combined the faces using most any morphing technology.

It will be understood that ‘morphing’ refers to an effect that changes (or morphs) one image into another. Most often morphing is used to depict one person turning into another through some magical or technological means or as part of a fantasy or surreal sequence. The users' clients would then display a morphed face that would combine elements from both participants' faces into a single face resembling a baby.

As an added effect, a feature control bar could be employed that would allow the users to have fun increasing or decreasing the amount of features of either user. Additionally, alternate aspects could include a screen button that would allow users to ‘try again,’ and attempt a new random version of the morphed face. Yet another aspect allows for faces of different ages with animated bodies, clothing and accessories to match the sex—e.g., ‘what would your offspring look like as a young woman?’ or ‘what would your offspring look like as a 60 year old adult?’

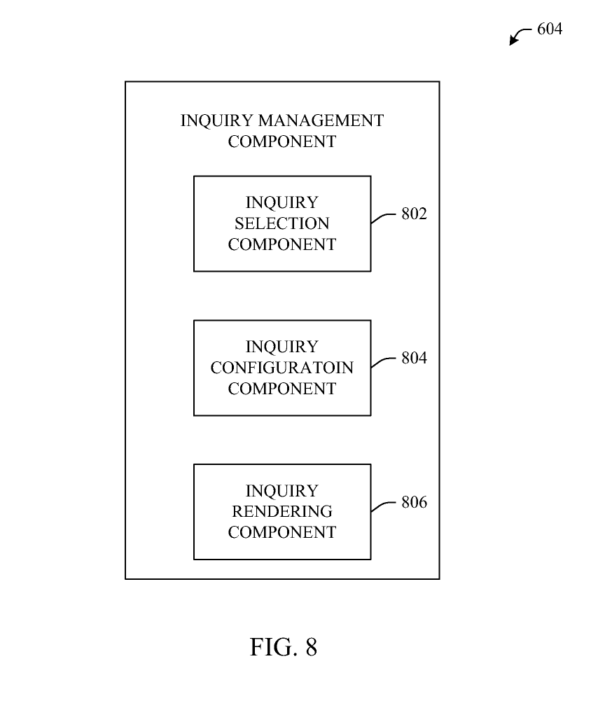

Referring now to FIG. 8, an example inquiry management component 604 is illustrated. Generally, the inquiry management component 604 includes an inquiry selection component 802, an inquiry configuration component 804 and an inquiry rendering component 806—each of these components will be described in more detail with regard to the examples that follow. Effectively, the inquiry management component 604 can be employed in games (or activities) where questions are posed to individuals to learn more about them, flirt, etc. Accordingly, answers to the questions can be analyzed or evaluated to thereafter make ‘crush’ or ‘flush’ determinations.

In accordance with example party chat games, a set of users can be given multiple choice questions or text questions, which they must answer during a specified time period. It is to be understood that the set of participants can be randomly selected, volunteers, based upon profile information and tags, etc. Essentially, most any determination and grouping criteria can be employed to construct a set of individuals. Additionally, the set can be two or more participants as desired. It will be appreciated that, due to the nature of some elimination-type games, an odd or even number of participants may be required so as to effectively enable the purpose of the game or activity.

As stated above, in accordance with these party chat games, users are posed questions and submit answers thereto. Decisions (e.g., crush or flush) can be made based upon answers to the questions. During the decision period, text chat discussions can occur to create a social atmosphere until the time expires.

A specific scenario of a party chat game can be referred to as ‘what would you do?’ This game refers to a flirting game where an even number (e.g., six) of users (e.g., three male and three female) read (or listen to pre-recorded audio) a short scenario background before making uncomfortable tradeoffs when answering the corresponding multiple-choice question about the scenario. This scenario can be presented by way of the inquiry selection, configuration and rendering components collectively 802, 804, 806.

It is to be appreciated that, in a heterosexual environment, the six-member set would comprise three women and three men. However, it is to be appreciated that homosexual and bi-sexual scenarios can exist—thus, the gender of participants would also change accordingly.

As users play the game, they can view the final answers of the other players together or independently of the chat discussion. In order to assess other participants, each participant can also view the profiles of other participants without leaving the game. Based on this information, users can declare ‘crushes’ upon each other.

In one example, the crushes stay hidden until there is a match. While other aspects reveal the crushes in hopes to solicit a mutual-crush. Once a mutual-crush is consummated, each of the users that have crushes on each other is pulled out of the game and directed into a private one-on-one discussion, while two new users are added to the game as replacements. As described above, the game application can be suspended while one-on-one communication takes place. While the example described employs text communication, it is to be understood that most any modality (e.g., voice call, video call . . . ) can be employed without departing from the spirit and scope of the innovation and claims appended hereto.

Yet another example of a party chat game can be referred to as ‘Eliminate’ or ‘Elimination’ where users are eliminated based upon responses to questions. In accordance with this scenario, one person (aka ‘leader’) would ask a defined number (e.g., five) of members of the opposite sex (or same sex in a homosexual or bi-sexual scenario) multiple choice questions or potentially text questions. In other aspects, voice and/or video can be used by the inquiry rendering component 706.

Based upon the answers, the leader could eliminate one of the participants after each question until only one person remains. The two remaining users (leader plus the surviving user) can then communicate privately. Effectively, this ‘elimination’ results in a mutual-crush thereby triggering an ability to communicate. In other aspects, the questions can be automatically generated (or selected) by the inquiry selection component 802. In other words, questions can be retrieved randomly or otherwise from an inquiry inventory.

Additionally, the inquiry configuration component 804 can be employed to configure the inquiry for delivery to the other participants. For instance, as participants can potentially speak different languages, the configuration component 804 can be employed to translate the question (and corresponding answer) into a language/dialect of the target participant. Similarly, the inquiries can be configured by the component 804 to conform to a particular target device. By way of example, if the target participant is using a landline to participate, text-to-speech mechanisms (and vice-versa) can be used to effect the functionality described above.

Yet another example of a party chat game is directed to a game referred to as ‘20 Questions.’ In this game, a small number (usually less than or equal to six) of users join a room and play the simple game of ‘20 questions.’ One of the users can be assigned, or volunteer for, a leadership position at the beginning of a round. In the instance of assignment, the server (e.g., gaming/activity component 108) can randomly or sequentially select the leader.

The leader then states what they are thinking of, for example, a person, place or thing. The users are then given turns to ask twenty (or some other specified number) yes/no questions of the leader. The users can pre-enter their text questions while waiting for the server to address them. If any of the users guess the answer, the server assigns him/her to the leadership position. If the twenty questions complete without a correct answer, the server can assign a new leader (either randomly or sequentially).

As users play the game, they can view the questions being asked, as well as user profiles of the other participants. Based upon this information, users can declare crushes on each other. These crushes stay hidden until there is a match or mutual-crush. Once a mutual-crush is consummated, the users that have crushes on each other are pulled out of the game into a private one-on-one discussion (e.g., text, voice, video, picture), while two new users are added to the game as replacements.

It is to be understood and appreciated that, in all the aforementioned example games, if any other users leave the game for whatever reason, they are replaced by users of the same sex. This replacement can be made based upon most any criteria including, but not limited to, participation history, profile data, tag data, wait time, etc.

Following are a few additional gaming examples directed to voice communication. With the ability to continue a time-managed, seamless experience from data application to voice and back to data application, service providers can provide a number of different multi-user experiences. Two such examples are described below, ‘Spin-the-Bottle’ and ‘Speed Dating.’

Referring first to ‘Spin-the-Bottle,’ this game is a random voice game in which the members of the available user base are selected to connect in two-person (or larger) voice calls sequentially based on some set of preferences. In one example, there are no time limits on the calls, and the matching process could potentially be random, well-determined, or a pre-determined.

Accordingly, the dating service (e.g., social interaction service, mobile interaction service) could support a ‘Spin-the-Bottle’ service where two users are randomly connected until one or both users decides to end the call. Once a call or communication is ended, the users can be automatically connected with the next set of users until they decide to stop playing. While a voice call example is described, it is to be understood that text messaging as well as video calls (described infra) can be employed without departing from the spirit and/or scope of the innovation.

An example methodological process of playing ‘Spin the Bottle’ is as follows—it is to be understood that the series of acts are merely an example of acts associated with a ‘Spin the Bottle’ scenario.

In the aspect, users agree voluntarily to play. Either before or after agreeing to play, preferences for criteria of a potential friend or mate can be set by each user. Once the game is initiated, each of the user's clients displays a profile of a potential mate for brief timed period. Upon seeing the profile, the users agree to talk (or otherwise communicate (e.g., text)). However, if either user does not agree to talk, a next random profile is displayed. It is to be understood that, in an alternative aspect, users can agree prior to seeing the profile of a potential mate. It will be understood that this example can enhance the spontaneity of the ‘Spin the Bottle” experience.

As described supra, once a mutual agreement (or ‘mutual-crush’) is effected, the ‘Spin the Bottle’ application is suspended. Thereafter, a call (or communication) can commence. Once the communication ends, by either user, by a time out or other communication ending event, the application restarts based upon the recorded state.

Thereafter, user's client devices display a feedback screen. It will be understood that this feedback can be used by the system to increase member confidence, match the user to other potential candidates, etc. Following, a next profile can be displayed.

Turning now to a discussion of timed voice games, these games are similar to random voice games except that the calls are timed. Generally, the users will be pre-selected in a defined set to ensure that the next call can start as soon as feedback ends for the previous call. While the feedback stage is described in connection with some of the examples, it is to be understood that this phase is optional and may not be included in alternative aspects.

An example of a timed game is ‘Speed-Dating,’ whereby a pre-determined set of users sign up for the game. To begin the game, the users sign in to ensure attendance at the start of the scheduled service. Thereafter, the application is suspended and a call (or other desired type of communication) commences.

The call continues for a specified period (e.g., 4 minutes) unless one of the users ends the call prematurely, in which case, the users are informed of their next call via a timer counting down. Thereafter, the application restarts and the users’ clients can display a feedback screen. Once feedback is complete, the next call starts and the game repeats. It is to be understood that users can join games immediately, or can sign up for a scheduled game at a later time.

Referring now to a discussion of video chat experiences in accordance with the functionality described herein. Traditionally, users of mobile phone social interaction services, such as mobile phone dating, can only text message the people with whom they desire to connect. Text messaging can be a very inefficient way to communicate over very long periods of time and/or for very long messages. Although text messaging functionality is provided, as described above, the subject innovation discloses extending mobile phone social interaction services to include voice and video calls. Accordingly, these modalities can be employed in gaming scenarios related to the social interaction environment.

Referring to video calls, this ability to communicate visually will allow users to get a real-time experience with potential friends and mates. As such, the user will know exactly how a person looks at that time, rather than the conventional use of profile photos which sometimes contributed untruthfulness and therefore lack of trust. Moreover, the innovation proposes a storage system to help users retrieve previous discussions as well as voice-mails. This storage system can aid users as they try to remember what conversation partners looked like, and how they acted, what they said, etc. As well, when users are not available, video mails can be stored for later viewing.

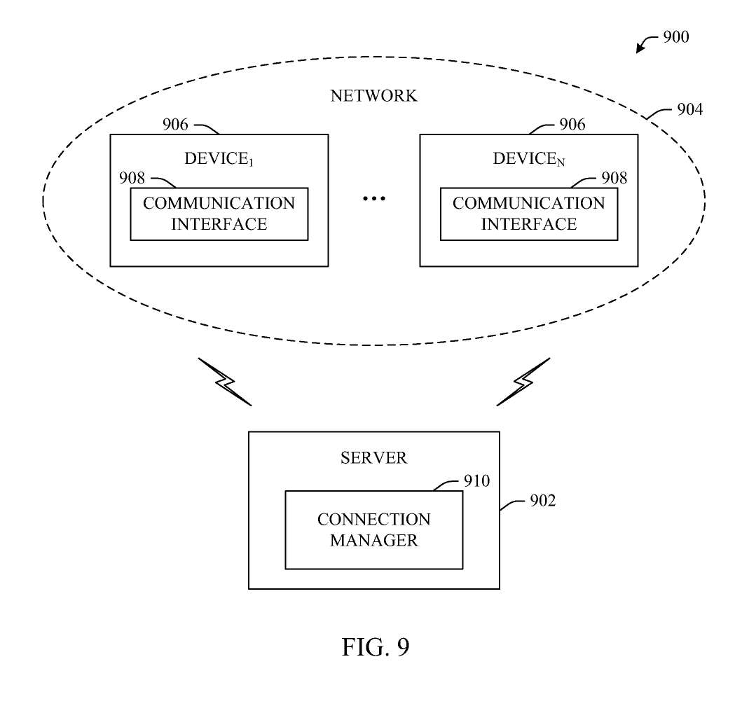

Referring now to FIG. 9, an alternative system 900 in accordance with an aspect of the innovation is shown. Generally, system 900 can include a server 902 and a network 904 having 1 to N devices therein, where N is an integer. Each device can be referred to individually or collectively as device 906. As well, each device 906 can include a communication interface component 908 having the same or similar functionality as communication interface component 102 of FIG. 1. As described herein, it is to be understood that the 1 to N devices 906 can be representative any wireless or wired device capable of interactive communication. As well, it is to be understood that the network 904 can include any combination of wired as well as wireless devices without departing from the spirit and scope of the innovation.

The server component 902 can include a connection manager 910 that controls the communications between devices 906 within the network 904. As well, the connection manager component 910 can control communication via a conventional wired telephone or other communication device. These alternative aspects are to be included within the scope of this innovation and claims appended hereto.

As described with reference to a voice call, a video call can be commenced at any time in accordance with a user preference or a predefined rule. Video chat can launch through an application or WAP interface via a server (e.g., 902) or via communication interface 908. The video call technology could be pre-integrated into the phone or could be leveraged via the social interaction service provider application. In the former, the video call could be run via a video conference server or other capable device co-located with the mobile operation. In the latter, the application could access a phone's camera to record images, and synchronize the image recording and playback with voice. The voice call could use the mobile operator, or a VoIP (Voice-over-Internet Protocol) technology that uses the phone's built-in microphone.

The following scenario is provided to add perspective to the innovation and is not intended to limit the scope of this disclosure in any way. More particularly, following is a description of more details with respect to the anonymous communication functionality of the innovation. As described above, two or more users can set up a call by agreeing to engage in an anonymous voice, video, picture-based or text conversation. Next, the users can schedule the call, for example, the call can occur immediately, or at some later time. Additionally, it can be determined if the call is to last for a specific period or to be indefinite in length. In aspects, this time constraint can be controlled by and depend upon on the service subscription and/or user decisions.

At the time of the call and with respect to launching the application, the social interaction service provider application may be necessary to enable video chat cases where the application manages the camera and/or provides VoIP. In these cases and if one of the parties to the call is not using the application at the time of the scheduled call, the application can be automatically launched as described above. During application launch, the user can be notified of the launch through a user preferred signal such as sound and/or vibration (or other notifying means).

The system 900 can further provide for anonymous video-mails. If users are unavailable when calls are sent, voice/video-mails can be enabled for listening viewing later. In order to maintain anonymity, the voice/video-mails will be linked to the username of the caller, not the real name or phone number.

In other aspects video chats can be stored and/or searched as desired. Users can have the option to store most any and all voice/video chats by setting preferences. These maintenance preferences can include, and are not limited to: all, by user, by type of user (friend or stranger), by discussion, and by discussion type. Additionally, users can decide to record a meeting at the time of the discussion, or right after the discussion. Moreover, the second party may require approval for the voice or video to be recorded. Similar to the above criteria, approval preferences include, but are not limited to: all, by user, by type of user (friend or stranger), by discussion and by discussion type. The second party can also approve the recording at the time of the discussion, or right after the discussion.

Stored chats can be searchable by any criteria, including but not limited to usemame, date, user-entered keywords (e.g., tags) as well as recognized words and phrases within the message or recording. The first two pieces of metadata can be recorded automatically. The keywords can be entered by the users after the call ends. The recognized words and phrases metadata can be generated through speech recognition software or the like. As with voice and video-mails described above, stored video chats can have all the standard playback capabilities as well as ‘slow-motion.’

Still other aspects of the innovation can provide for mobile multi-user anonymous voice and/or video chat. As described above, conventional users of mobile phone social interaction services are limited to text chat as a way of meeting and interacting with people. As further stated above, text chat on mobile phones is very limiting for a number of reasons. First and foremost, text messaging is difficult to enter the text via a small mobile device keypad. As well, the experience does not feel ‘real’ because users can not see or hear the person as they chat. In other words, as with email communication, text messaging strips the message of any intonation and emotion, or alternatively conveys an unwanted tone and/or emotion. With respect to the social networking, interaction or matchmaking scenario, text messaging further limits the user's ability to detect any ‘chemistry’ with the other party.

In one particular example of the invention, groups of users can initiate and/or join in video chats. These virtual ‘chat rooms’ can allow users to watch and listen to the other members, while doing many of the things that users do today in most text chat rooms, including, but not limited to sending private messages to individual users, and viewing user profiles.

Turning now to a discussion of mobile multi-player video chat, it is to be understood that the innovation describes scenarios whereby video chat can be employed in the context of games or other entertainment activities. As described above, current users of mobile phone social services are limited to text chat as a mechanism of meeting and interacting with people. It will be appreciated that text chat via mobile phones is very limiting for a number of reasons. For instance, due to the mobile device keyboard structures, it is difficult to enter the text. Additionally, the text messaging experience does not feel ‘real’ because users cannot see or hear the person as they chat. In other words, intonation and emotion are lost. For mobile dating, the text further limits the user's ability to detect any ‘chemistry.’

The subject innovation, by using video and voice chat, enables groups of users (e.g., less than or equal to six) will be able to join in video chats. These chat rooms allow users to watch and listen to the other members, while doing many of the things that users do today in most text chat rooms, including, but not limited to sending private messages to individual users, and viewing user profiles. The technology can comprise at least the following components.

First, the innovation enables maintenance of anonymity despite the visual appearance of the user. In other words, users can be referred to by their username—their phone number, real name and other identifiable information will remain hidden completely.

In addition to maintaining anonymity, the innovation provides the ability for a user to choose or join a room as desired. In one example, the video chat rooms can be listed or sorted by most any criteria that is valuable to the user base, such as, but not limited to, subject, popularity, median age, location of occupants, male/female ratio, etc. In operation, users can simply click on their chosen room to enter.

Further, the innovation enables viewing of video streams of other users, members or candidates. In aspects, there can be a variety of ways to view the streams. Additionally, users can have the ability to switch views through controls (e.g., buttons) on the keypad as well as links in the user interface (as well as voice activated controls).

In many embodiments, there can be a self-view which provides a user an ability to view their own video stream—thus, a user can ensure a good stream for others to view. In the multi-stream viewer described infra, the self-view can be one of the six streams. In the other cases, there can be a small self-view stream shown which is much smaller than the stream of the other user(s).

The multi-stream viewer allows the user to see all the participants of the chat room(s). Given the average mobile phone screen size, most often a limited number (e.g., only six) of streams could be shown simultaneously. Thus, in an example, chat rooms could be limited to six people, or users could choose to view a set of six simultaneous streams out of the complete list of users in the room. If the user selects less than six streams, or if the chat room has less than six users, the size of the individual stream views can automatically increase to encompass as much area of the phone screen as possible. It is to be understood that the six stream example is but one example and is not intended to limit the innovation in any way. Rather, it is to be understood that other aspects can include more or less than six streams without departing from the spirit and/or scope of the innovation.

In accordance with an auto-stream viewer embodiment, only one stream will be shown at a time in this viewer—wherein the single stream can be chosen automatically by the application. For instance, if the auto-stream viewer embodiment is employed in connection with a telephonic conference, the auto-viewer will focus upon the user with the microphone control. It will be understood that microphone control can switch automatically via microphone volume (as in half-duplex audio) or via a manual setting. This viewer can be particularly useful for small numbers of users.

In a single-choice viewer, users scroll through a list of users and/or a grid of streams (as in the multi-stream viewer). However, here the user selects the user they prefer to view and hear. They can then click back to the user list at any time, or click to the ‘next stream’ as desired. There are at least two options when listening to video streams depending on whether the user voices are conferenced together or treated as separate streams. In the former, the users can listen to the full-duplex or half-duplex conversation. In the latter, each user can only listen to one other user's stream. It is to be understood that the user can select this stream in a similar fashion to that described under ‘single-choice viewer’ above, but they can have the option of viewing more than one video stream even if they only listen to one stream. In the case of a multi-stream view while listening to only one stream, the stream the user is hearing can be highlighted (or designated in some other suitable manner).

It will be understood that the innovation provides for a user to be able to report inappropriate content or conduct. Here, any user will be able to report inappropriate content from any of the viewers mentioned above. This feature can be implemented a number of ways, including, but not limited to, links at the bottom of the screen or a right-button link, among others.

While video chat can be used in connection with the aforementioned games/activities, following are examples of the use of video games in yet other scenarios. As stated above, most current downloadable and WAP games for the mobile phone are solitary games, although users would like to use the phone to visually interact with others. Also, traditionally, when users interact, they typically send text messages back and forth asynchronously. Here, the innovation discloses social networking games/activities to introduce people, and also to help them to learn more about each other in a real-time format. These games employ advanced mobile service capabilities whereby voice and data could occur simultaneously, and also video call capability exists.

A first example of a game that employs advanced text, picture-based, voice and video technology is a ‘Five Alive Dating Game.’ In this game, five members of the available user base are selected to connect in voice or video conference. Users choose mates, and, if the feelings are mutual (e.g., mutual-crush), the pairs exit the conference and are replaced. While the example is provided with five members, it is to be understood that most any odd number of users can be selected in alternative aspects.

In accordance with this game, the matching process is essentially random, but user preferences might require that the five users be chosen from a subset of the user base. This subset could be based interests, physical attributes, age, location, height, community tag, certified tag, or any other personal characteristic. Also, the five must contain two potential sets of paired mates (e.g., 3 males and 2 females forming 2 couples and an extra in a heterosexual aspect). It will be understood that the gender of each of the set of members will be selected based upon the type of environment, e.g., heterosexual, homosexual, or bi-sexual.

During play, participants are instructed to chat, choose a mate, and indicate their choice. During the chatting experience, participants have the capability of viewing participant profiles and, if the option is available, viewing live video streams of the participants. Once they make their decision, they indicate their decision, for example, by clicking on the username. These decisions are kept hidden from the user unless there is a mutual match (e.g., mutual-crush).

If two users both indicate that they are interested in each other (e.g., mutual crush), then they are immediately taken out of the discussion into a one-on-one communication session (voice or video, if available). Simultaneously (or shortly thereafter), two users are selected to replace them. Replacements are chosen to maintain the two potential sets of paired mates. For example, if a male and female leave the room, then a male and female could replace them. It will be understood that the game can continue indefinitely in this fashion. Once the one-on-one call is completed, the two users are invited to give feedback on the other party.

In another example (e.g., ‘Eliminate’), five members of the available user base are selected to connect in voice or video conference. One user is the chooser, and the other four must try to win him/her over. As the chat progresses, the suitors are rejected, one by one, until only one is left. At that point, the pair is connected via a one-on-one voice or video chat.

In this example, the matching process is essentially random, but user preferences might require that the five be chosen from a particular subset of the user base. This subset could be based on interests, physical attributes, location, age or any other personal characteristic. Also, the five must include only one potential set of paired mates (e.g., 4 males and 1 female forming 1 couple and 4 extras in a heterosexual scenario).

In this game, the chooser is instructed to chat and eliminate participants until he/she is left with his/her final choice. During the chatting experience, the chooser has the capability of viewing participant profiles and, if the option is allowed, viewing live video streams of the participants. Once the chooser is left with his/her final choice, the pair can continue to chat as long as they desire in a one-on-one voice or video chat, if video is allowed. As users are eliminated, they can be placed in another Eliminate game, if they are interested. Once the one-on-one call is completed, the two users can be invited to give feedback on the other party.

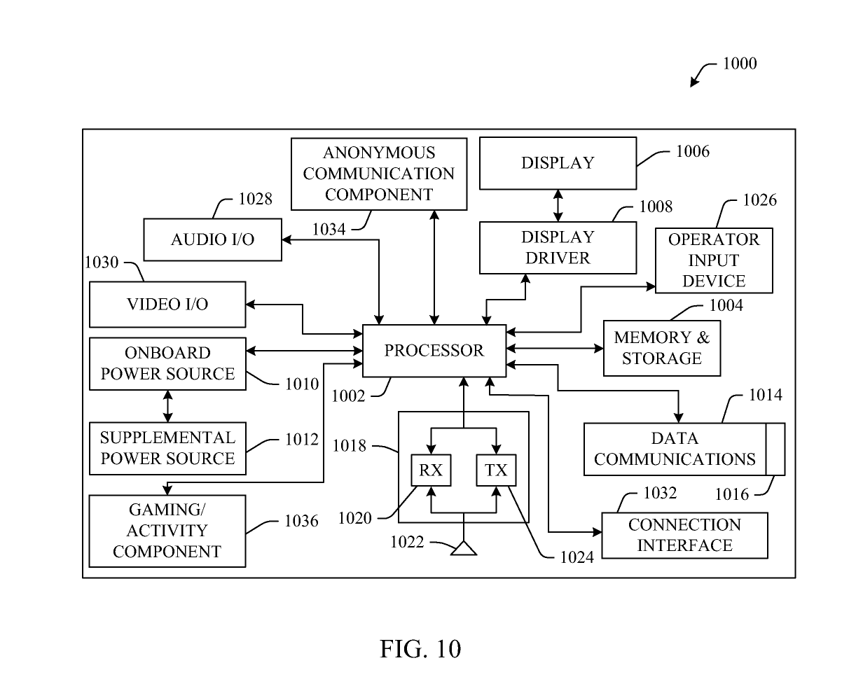

Referring now to FIG. 10, there is illustrated a schematic block diagram of a portable hand-held device 1000 according to one aspect of the subject invention, in which a processor 1002 is responsible for controlling the general operation of the device 1000. The processor 1002 can be programmed to control and operate the various components within the device 1000 in order to carry out the various novel functions described herein. The processor 1002 can be any of a plurality of suitable processors. The manner in which the processor 1002 can be programmed to carry out the functions relating to the subject innovation will be readily apparent to those having ordinary skill in the art based on the description provided herein. As will be described in greater detail infra, an artificial intelligence (AI) reasoning component can be used to effect an automatic action of processor 1002.

A memory and storage component 1004 connected to the processor 1002 serves to store program code executed by the processor 1002, and also serves as a storage means for maintaining information such as data, services, metadata, device states, electronic mail messages, or the like. The memory 1004 can be a non-volatile memory suitably adapted to store at least a complete set of the information that is acquired. Thus, the memory 1004 can include a RAM or flash memory for high-speed access by the processor 1002 and/or a mass storage memory, e.g., a micro drive capable of storing gigabytes of data that comprises text, images, audio, and video content. According to one aspect, the memory 1004 has sufficient storage capacity to store multiple sets of information relating to disparate services, and the processor 1002 could include a program for alternating or cycling between various sets of information corresponding to disparate services.

A display 1006 can be coupled to the processor 1002 via a display driver system 1008. The display 1006 can be a color liquid crystal display (LCD), plasma display, touch screen display or the like. In one example, the display 1006 is a touch screen display. The display 1006 functions to present data, graphics, or other information content via a UI. Additionally, the display 1006 can display a variety of functions that control the execution of the device 1000. For example, in a touch screen example, the display 1006 can display touch selection buttons. In operation, when the state is restored, the UI, via display 1006, can effectively convey the state of the device.

Power can be provided to the processor 1002 and other components forming the hand-held device 1000 by an onboard power system 1010 (e.g., a battery pack). In the event that the power system 1010 fails or becomes disconnected from the device 1000, a supplemental power source 1012 can be employed to provide power to the processor 1002 (and other components (e.g., image capture device)) and to charge the onboard power system 1010. The processor 1002 of the device 1000 can induce a sleep mode to reduce the current draw upon detection of an anticipated power failure.

The device 1000 includes a communication subsystem 1014 having a data communication port 1016, which is employed to interface the processor 1002 with a remote computer, server, service, or the like. The port 1016 can include at least one of Universal Serial Bus (USB) and IEEE 13104 serial communications capabilities. Other technologies can also be included, but are not limited to, for example, infrared communication utilizing an infrared data port, Bluetooth™, wireless protocols, etc.

The device 1000 can also include a transceiver section 1018 inoperative communication with the processor 1002. The transceiver section 1018 includes a receiver 1020, which receives signals from a remote device via an antenna 1022 and can process the signal to obtain digital information therein. The transceiver section 1018 also includes a transmitter 1024 for transmitting information (e.g., data, service) to a remote device, for example, in response to manual user input via a operator input 1026 (e.g., a keypad).

The transceiver section 1018 facilitates communication with other portable devices and/or host computer systems. In furtherance thereof, an audio I/O section 1028 is provided as controlled by the processor 1002 to process voice input from a microphone (or similar audio input device) and can transmit audio output signals (from a speaker or similar audio output device).

In another implementation, the device 1000 can provide speech recognition capabilities such that when the device 1000 is used as a voice activated device, the processor 1002 can facilitate high-speed conversion of the voice signals into text or operative commands. For example, the converted voice signals can be used to control the device 1000 in lieu of using manual entry via the keypad 1026. As well, in another aspect, voice commands can be employed to effect coupling and/or decoupling from a remote system.

Similarly, video signals can be input and/or output via the video I/O component 1032. The video I/O component 1032 can include an image capture device capable of providing video communications via the mobile device 1000.

Other components such as a connection interface 1032 and an anonymous communication component 1034 can be provided within the housing of the device 1000 to effectuate functionality described supra. For example, the connection interface 1032 can be employed in connection with storing a state of the application/service upon connection of a call. As well, the anonymous communication component 1034 can be employed to mask the identity of a party to a scheduled meeting. Still further, the gaming/activity component 1036 can be employed to facilitate social network gaming/activities as described herein.

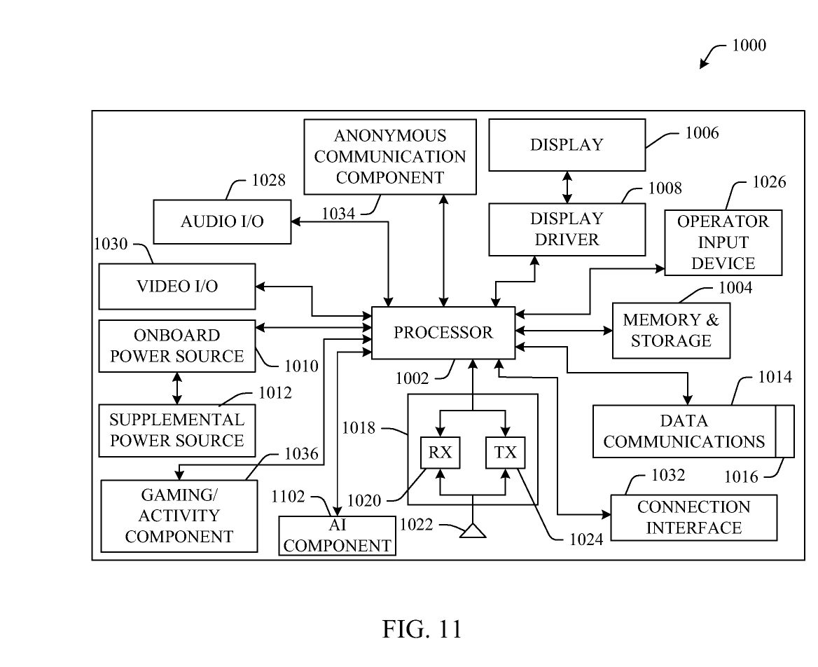

FIG. 11 illustrates a system 1100 that employs an AI (or machine learning & reasoning) component 1102 which facilitates automating one or more features in accordance with the subject innovation. The subject invention (e.g., with respect to selecting candidates, automatically masking identity, monitoring state, selecting a return state, etc.) can employ various AI-based schemes for carrying out various aspects thereof. For example, a process for determining a time to schedule a meeting or a state to which to return the application upon completion of a call can be facilitated via an automatic classifier system and process.

A classifier is a function that maps an input attribute vector, x=(x1, x2, x3, x4, xn), to a class label class(x). A classifier can also output a confidence that the input belongs to a class, that is, f(x)=confidence(class(x)). Such classification can employ a probabilistic and/or statistical-based analysis (e.g., factoring into the analysis utilities and costs) to infer an action that a user desires to be automatically performed.

A support vector machine (SVM) is an example of a classifier that can be employed. The SVM operates by finding a hypersurface in the space of possible inputs that splits in an optimal way the triggering input events from the non-triggering events. Intuitively, this makes the classification correct for testing data that is identically distributed to training data. Other classification approaches, including Naïve Bayes, Bayesian networks, decision trees, neural networks, fuzzy logic models, maximum entropy models, etc., can be employed. Classification as used herein also is inclusive of statistical regression that is utilized to develop models of priority.

As will be readily appreciated from the subject specification, the subject invention can employ classifiers that are pre-trained (e.g., via a generic training data from multiple users) as well as methods of reinforcement learning (e.g., via observing user behavior, observing trends, receiving extrinsic information). Thus, the subject invention can be used to automatically learn and perform a number of functions, including but not limited to determining, according to a predetermined criteria, candidates to select, times for meetings, restore state of an application upon completion of a call, etc.

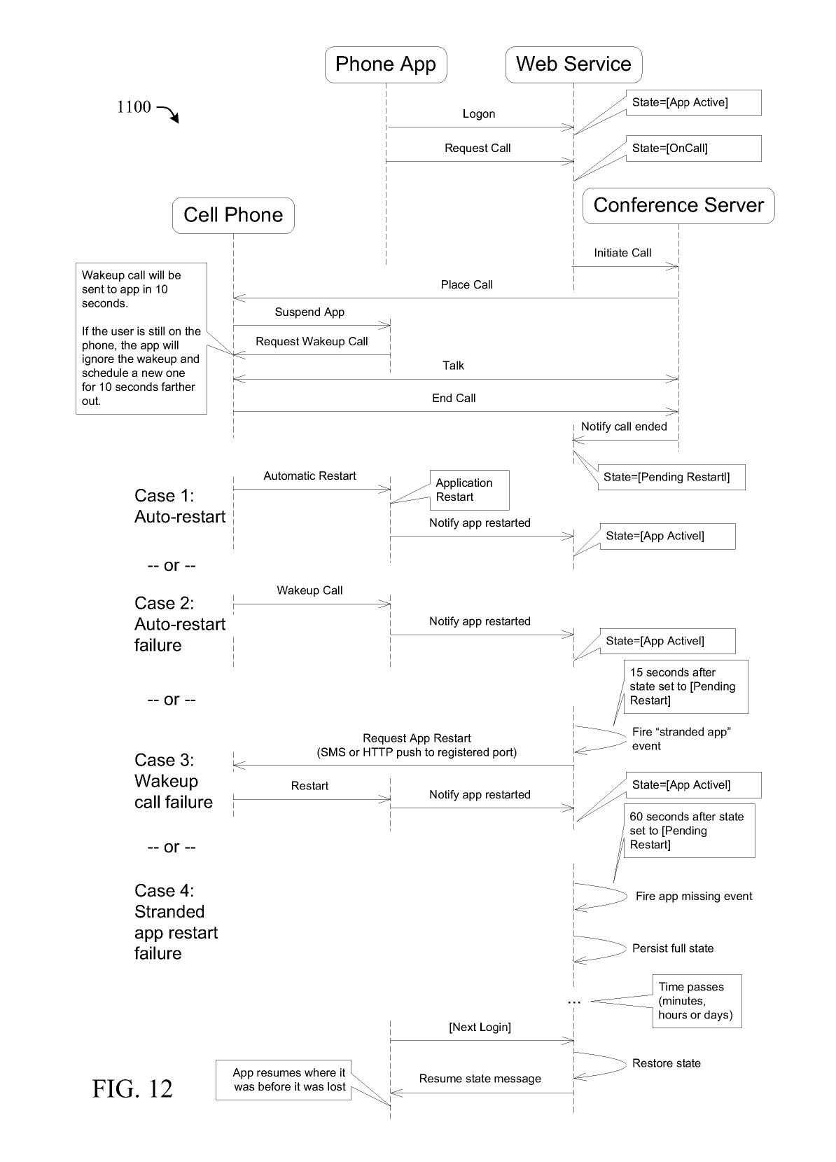

Turning now to FIG. 12, a failsafe application restart process flow in accordance with an aspect of the innovation is shown. More particularly, FIG. 12 illustrates four exemplary process flow case scenarios that correspond to alternative aspects of the innovation.

Although specific process flow scenarios are shown in FIG. 12, it is to be understood and appreciated that other aspects can exist and are to be included within the scope of the disclosure and claims appended hereto. As well, it is to be understood that the case scenarios illustrated can vary based upon other situational factors and/or preferences.

For example, with reference to case 4, upon resume, it is not imperative that the application install at the state before it became lost. As well, the application can could have been lost or abandoned on a separate device. Once restarted on another device, the state could be resumed on the replacement device. All in all, the novel aspects of interruption and restart can be applied to countless scenarios, each of which is to be included within the scope of the innovation and claims appended hereto.

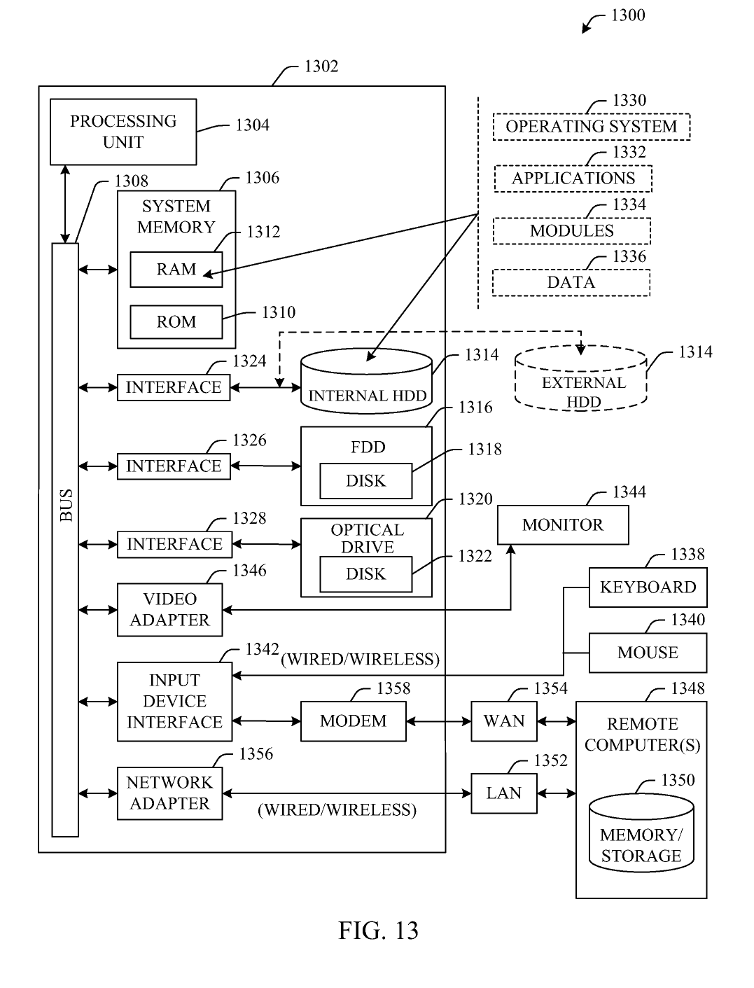

Referring now to FIG. 13, there is illustrated a block diagram of a computer operable to execute the disclosed architecture. In order to provide additional context for various aspects of the subject innovation, FIG. 13 and the following discussion are intended to provide a brief, general description of a suitable computing environment 1300 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the innovation includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

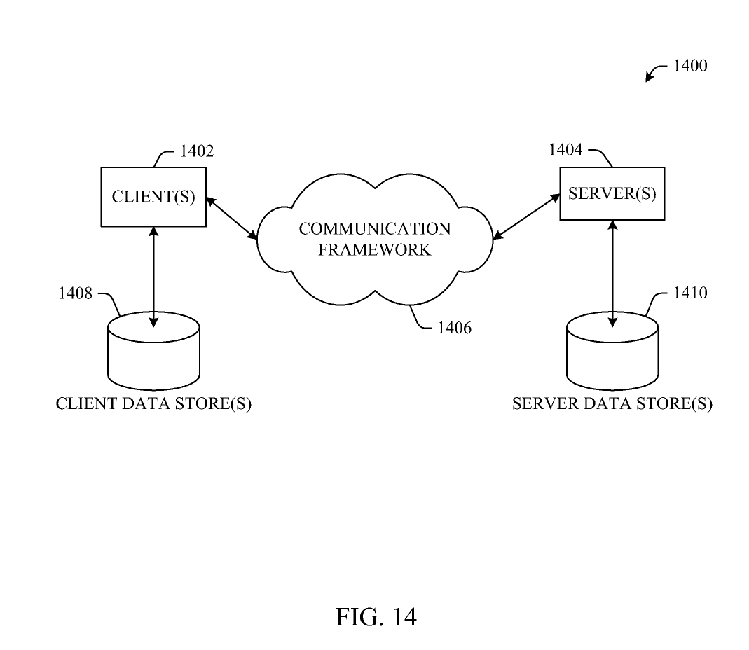

Referring now to FIG. 14, there is illustrated a schematic block diagram of an exemplary computing environment 1400 in accordance with the subject innovation. The system 1400 includes one or more client(s) 1402. The client(s) 1402 can be hardware and/or software (e.g., threads, processes, computing devices). The client(s) 1402 can house cookie(s) and/or associated contextual information by employing the innovation, for example.

The system 1400 also includes one or more server(s) 1404. The server(s) 1404 can also be hardware and/or software (e.g., threads, processes, computing devices). The servers 1404 can house threads to perform transformations by employing the innovation, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term ‘includes’ is used in either the detailed description or the claims, such term is intended to be inclusive in a manner similar to the term ‘comprising’ as ‘comprising’ is interpreted when employed as a transitional word in a claim.

What is claimed is:

1. A communication system that facilitates gaming between a plurality of users in a social networking environment, comprising:
a gaming/activity component that facilitates an entertainment activity between a subset of the plurality of users, wherein the subset is defined by a desired parameter and the entertainment activity triggers a private communication session between at least two of the subset of users; and
a connection interface component that schedules the private communication session.

2. The communication system of claim 1, further comprising an anonymous communication component that establishes the private communication session such that identity of each party to the exchange is unknown.

3. The communication system of claim 1, wherein the entertainment activity is a text only game.

4. The communication system of claim 1, wherein the entertainment activity is a voice-based game.

5. The communication system of claim 1, wherein the entertainment activity is a visual-based game.

6. The communication system of claim 1, where the entertainment activity is at least one of ‘Right Now,’ ‘Babyface,’ ‘What would you do?,’ ‘Eliminate,’ ‘20 Questions,’ ‘Spin the Bottle,’ ‘Five Alive,’ or ‘Speed Dating.’

7. The system of claim 1, further comprising a photo management component the administers a plurality of photos within the entertainment activity.

8. The system of claim 7, further comprising a photo configuration component that one of orders or stitches a photo of a first user with a photo of a second user in accordance with the entertainment activity.

9. The system of claim 7 further comprising a photo manipulation component that morphs a facial photo of a first user with a facial photo of a second user in accordance with the entertainment activity.

10. The system of claim 7, further comprising a photo rendering component that dynamically adjusts a photo based upon a parameter of a target display device in accordance with the entertainment activity.

11. The system of claim 1, further comprising an inquiry management component that administers a plurality of questions within the entertainment activity.

12. The system of claim 11, further comprising an inquiry selection component that randomly selects a plurality of questions from an inventory in accordance with the entertainment activity.

13. The system of claim 11, further comprising an inquiry configuration component that translates a question into a language comprehendible by a user.

14. The system of claim 11, further comprising an inquiry rendering component that delivers a question to an appropriate participant in accordance with the entertainment activity.

15. A system that facilitates gaming in a social network environment, comprising:
a social interaction component having a plurality of candidates therein; each candidate employs a device having a communication interface; and
a gaming activity component that connects a subset of candidates in a gaming environment.

16. The system of claim 15, the server includes a connection manager that masks identity of each of subset of the plurality of candidates.

17. The system of claim 16, the gaming environment facilitates at least one of ‘Right Now,’ ‘Babyface,’ ‘What would you do?,’ ‘Eliminate,’ 1 20 Questions,’ ‘Spin the Bottle,’ ‘Five Alive,’ or ‘Speed Dating.’

18. A computer-implemented method of gaming within a social interaction environment, comprising:
launching a social interaction game;
linking a plurality of candidates within a gaming environment;
selecting a subset of the candidates for a private communication session;
suspending the social interaction game;
enabling the private communication session;
terminating the private communication session;
initiating feedback related to the subset of candidates; and
restarting the social interaction game based upon state at suspension.

19. The computer-implemented method of claim 18, wherein the gaming environment includes one of a photo-based game or an inquiry based game.

20. The computer-implemented method of claim 18, the act of enabling the private communication session originates via at least one of a wireless device, a landline or a VoIP (Voice-over-Internet Protocol) equipped personal computer.
